(19) United States
(12) Patent Application Publication
(10) Pub. No.: US 2016/0001668 A1
(43) Pub. Date: Jan. 7, 2016

(54) POWER TRANSMISSION DEVICE, POWER RECEPTION DEVICE, VEHICLE, AND CONTACTLESS POWER FEEDING SYSTEM

(71) Applicant: Shinji ICHIKAWA, (US)

(72) Inventor: Shinji ICHIKAWA, Toyota-shi (JP)

(73) Assignee: TOYOTA JIDOSHA KABUSHIKI KAISHA, Toyota-shi (JP)

(21) Appl. No.: 14/648,410

(22) PCT Filed: Mar. 22, 2013
(86) PCT No.: PCT/JP2013/058295

§ 371 Date: May 29, 2015

(51) Int. Cl. B60L 11/18

(52) U.S. Cl. CPC B60L 11/1829; B60L 11/182

(57) ABSTRACT

A contactless power feeding system is configured to supply power from a power transmission unit to a power reception unit in a contactless manner. The contactless power feeding system includes a raising and lowering mechanism that moves the power reception unit between a standby position and a power reception position facing the power transmission unit, and an ECU for controlling the raising and lowering mechanism. After the power reception unit has been moved to the power reception position and during reception of power from the power transmission unit, when a distance between the power transmission unit and the power reception unit becomes greater than the distance at a start of the reception of power, the ECU operates the moving device to bring the power reception unit closer to the power transmission unit. Consequently, a reduction in power transfer efficiency during power transmission can be prevented.

### TECHNICAL FIELD

The present invention relates to power transmission devices, power reception devices, vehicles, and contactless power feeding systems, and more particularly to a technique of improving power transfer efficiency in a contactless power feeding system.

### BACKGROUND ART

In recent years, attention has been drawn to contactless and wireless power transfer without a power code or a power transmission cable. It has been proposed to apply this power transfer to an electric car, a hybrid vehicle and the like in which a power storage device mounted thereon can be charged with power from a power supply outside of the vehicle (hereinafter also referred to as an “external power supply”).

In such a contactless power feeding system, proper alignment between the power transmission and the power reception is important so as to improve power transfer efficiency.

Japanese Patent Laying-Open No. 2011-036107 (PTD 1) discloses a charging system of transferring power in a contactless manner between a power reception coil provided on a vehicle and a power transmission coil provided on the ground, in which a position adjustment unit is provided that adjusts a position of the power transmission coil such that the power transmission coil and the power reception coil have positional relation in which they are electromagnetically coupled together.

Japanese Patent Laying-Open No. 2011-193617 (PTD 2) discloses a contactless power feeding system of a vehicle, in which the vehicle is provided with a raising and lowering device that raises and lowers a power reception coil provided on the vehicle to bring the power reception coil closer to a power transmission coil.

### CITATION LIST

### Patent Documents

### PTD 1: Japanese Patent Laying-Open No. 2011-036107

### PTD 2: Japanese Patent Laying-Open No. 2011-193617

### SUMMARY OF INVENTION

### Technical Problem

In a contactless power feeding system, power transfer efficiency may vary depending on the positional relation between a power transmission unit of a power transmission device and a power reception unit of a power reception device.

According to the configurations disclosed in Japanese Patent Laying-Open No. 2011-036107 (PTD 1) and Japanese Patent Laying-Open No. 2011-193617 (PTD 2), the positional relation between the power transmission unit and the power reception unit can be adjusted so as to improve the power transfer efficiency therebetween prior to the start of power transmission.

In a system of feeding power to a vehicle, however, a vehicle height may vary due to boarding/alighting of an occupant or loading/unloading of baggage to and from a trunk room during power transfer. This vehicle height variation may in turn affect the power transfer efficiency.

The present invention has been made to solve such a problem, and an object of the present invention is to prevent a reduction in power transfer efficiency during power transfer in a contactless power feeding system provided with a moving device capable of adjusting positional relation between a power transmission unit and a power reception unit.

### Solution to Problem

A vehicle according to the present invention is capable of receiving power from a power transmission device in a contactless manner. The vehicle includes a power reception unit that receives power from a power transmission unit included in the power transmission device in a contactless manner, a moving device configured to move the power reception unit between a standby position and a power reception position facing the power transmission unit, and a control device for controlling the moving device. After the power reception unit has been moved to the power reception position and during reception of power from the power transmission unit, when a distance between the power transmission unit and the power reception unit becomes greater than the distance at a start of the reception of power, the control device is configured to operate the moving device to bring the power reception unit closer to the power transmission unit.

Preferably, the control device causes the power transmission unit to suspend power transmission and reoperates the moving device so as to adjust the distance when the distance becomes greater than a first predetermined value during the reception of power from the power transmission unit.

Preferably, the control device causes the power transmission unit to restart the power transmission in response to the distance becoming smaller than a second predetermined value by the reoperation of the moving device, the second predetermined value being set to be equal to or lower than the first predetermined value.

Preferably, the control device determines the distance based on power transfer efficiency from the power transmission unit to the power reception unit.

Preferably, the control device causes the power transmission unit to suspend power transmission and operates the moving device when the power transfer efficiency becomes lower than a first threshold value, and causes the power transmission unit to restart the power transmission in response to the power transfer efficiency becoming higher than a second threshold value, the second threshold value being set to be equal to or higher than the first threshold value.

Preferably, a difference between a natural frequency of the power transmission unit and a natural frequency of the power reception unit is ±10% or less of the natural frequency of the power transmission unit or the natural frequency of the power reception unit.

Preferably, a coefficient of coupling between the power transmission unit and the power reception unit is not less than 0.6 and not more than 0.8.

Preferably, the power reception unit receives power from the power transmission unit through at least one of a magnetic field formed between the power reception unit and the power transmission unit and oscillating at a specific frequency, and an electric field formed between the power reception unit and the power transmission unit and oscillating at a specific frequency.

A power reception device according to the present invention receives power from a power transmission device in a contactless manner. The power reception device includes a power reception unit that receives power from a power transmission unit included in the power transmission device in a contactless manner, a moving device configured to move the power reception unit between a standby position and a power reception position facing the power transmission unit, and a control device for controlling the moving device. After the power reception unit has been moved to the power reception position and during reception of power from the power transmission unit, when a distance between the power transmission unit and the power reception unit becomes greater than the distance at a start of the reception of power, the control device is configured to operate the moving device to bring the power reception unit closer to the power transmission unit.

A power transmission device according to the present invention supplies power to a power reception device in a contactless manner. The power transmission device includes a power transmission unit that supplies power to a power reception unit included in the power reception device in a contactless manner, a moving device configured to move the power transmission unit between a standby position and a power transmission position facing the power reception unit, and a control device for controlling the moving device. After the power transmission unit has been moved to the power transmission position and during transmission of power to the power reception unit, when a distance between the power transmission unit and the power reception unit becomes greater than the distance at a start of the reception of power, the control device is configured to operate the moving device to bring the power transmission unit closer to the power reception unit.

A contactless power feeding system according to the present invention includes a power transmission unit and a power reception unit, and supplies power from the power transmission unit to the power reception unit in a contactless manner. The contactless power feeding system includes a moving device configured to move at least one of the power transmission unit and the power reception unit from a standby position to a power reception position, and a control device for controlling the moving device. During reception by the power reception unit of power from the power transmission unit in the power reception position, when a distance between the power transmission unit and the power reception unit becomes greater than the distance at a start of the reception of power, the control device is configured to operate the moving device to bring the power reception unit and the power transmission unit closer to each other.

### Advantageous Effects of Invention

According to the present invention, in the contactless power feeding system provided with the moving device capable of adjusting positional relation between the power transmission unit and the power reception unit, when the distance between the power transmission unit and the power reception unit varies during power transfer, the positional relation between the power reception unit and the power transmission unit can be readjusted by means of the moving device. Consequently, a reduction in power transfer efficiency during power transfer resulting from the variation in distance between the power transmission unit and the power reception unit can be prevented.

### BRIEF DESCRIPTION OF DRAWINGS

FIG. 1 is an overall configuration diagram of a contactless power feeding system of a vehicle according to an embodiment of the present invention.

FIG. 2 is a diagram for illustrating the operation of a raising and lowering mechanism shown in FIG. 1.

FIG. 3 is an overall configuration diagram of another example of the contactless power feeding system of the vehicle according to the embodiment of the present invention.

FIG. 4 is an equivalent circuit diagram during power transfer from a power transmission device to the vehicle.

FIG. 5 is a diagram showing a simulation model of a power transfer system.

FIG. 6 is a diagram showing relation between deviation in natural frequency of a power transmission unit and a power reception unit, and power transfer efficiency.

FIG. 7 is a graph showing relation between the power transfer efficiency when an air gap is changed with the natural frequency being fixed, and a frequency of current supplied to the power transmission unit.

FIG. 8 is a diagram showing relation between a distance from an electric current source (magnetic current source) and the strength of an electromagnetic field.

FIG. 9 is a diagram for illustrating a summary of charging operation when there is no variation in vehicle height during power transfer in this embodiment.

FIG. 10 is a diagram for illustrating a summary of charging operation when there is a variation in vehicle height during power transfer in this embodiment.

FIG. 11 is a flowchart for illustrating control of readjusting a position of the power reception unit which is performed during power transfer in this embodiment.

FIG. 12 is a flowchart for illustrating control of readjusting a position of the power reception unit which is performed during power transfer in this embodiment.

### DESCRIPTION OF EMBODIMENTS

An embodiment of the present invention will be described below in detail with reference to the drawings, in which the same or corresponding parts are designated by the same characters and description thereof will not be repeated.

(Configuration of Contactless Power Feeding System)

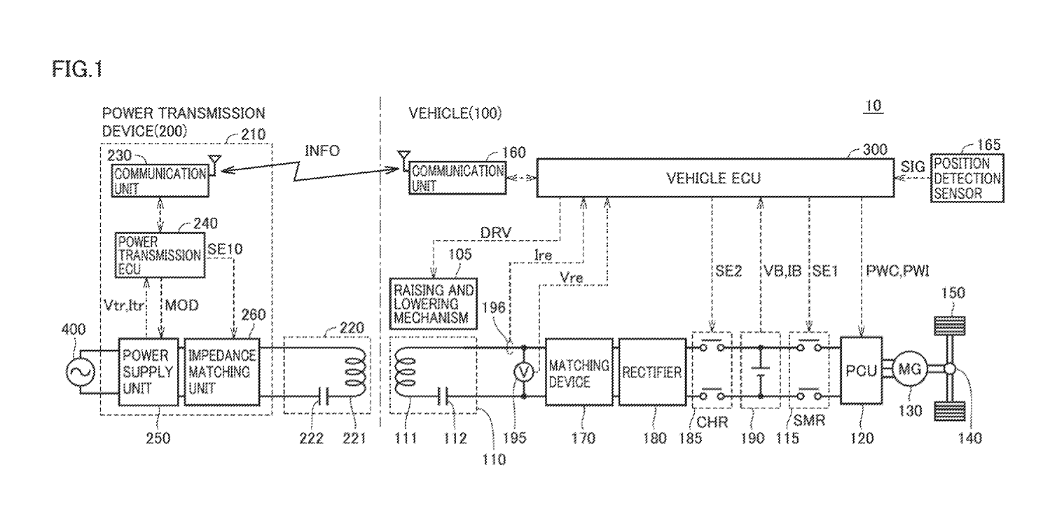

FIG. 1 is an overall configuration diagram of a contactless power feeding system 10 according to this embodiment. Referring to FIG. 1, contactless power feeding system 10 includes a vehicle 100 and a power transmission device 200.

Power transmission device 200 includes a power supply device 210 and a power transmission unit 220. Power supply device 210 generates AC power having a predetermined frequency. By way of example, power supply device 210 generates high-frequency AC power with power received from a commercial power supply 400, and supplies the generated AC power to power transmission unit 220. Power transmission unit 220 then outputs the power to a power reception unit 110 of vehicle 100 in a contactless manner through an electromagnetic field generated around power transmission unit 220.

Power supply device 210 includes a communication unit 230, a power transmission ECU 240 serving as a control device, a power supply unit 250, and an impedance matching unit 260. Power transmission unit 220 includes a resonant coil 221 and a capacitor 222.

Power supply unit 250 is controlled by a control signal MOD from power transmission ECU 240, and converts power received from an AC power supply such as commercial power supply 400 to high-frequency power. Power supply unit 250 then supplies the converted high-frequency power to resonant coil 221 through impedance matching unit 260.

Power supply unit 250 also outputs a power transmission voltage Vtr and a power transmission current Itr detected by a voltage sensor and a current sensor not shown, respectively, to power transmission ECU 240.

Impedance matching unit 260 is for matching an input impedance of power transmission unit 220, and typically includes a reactor and a capacitor.

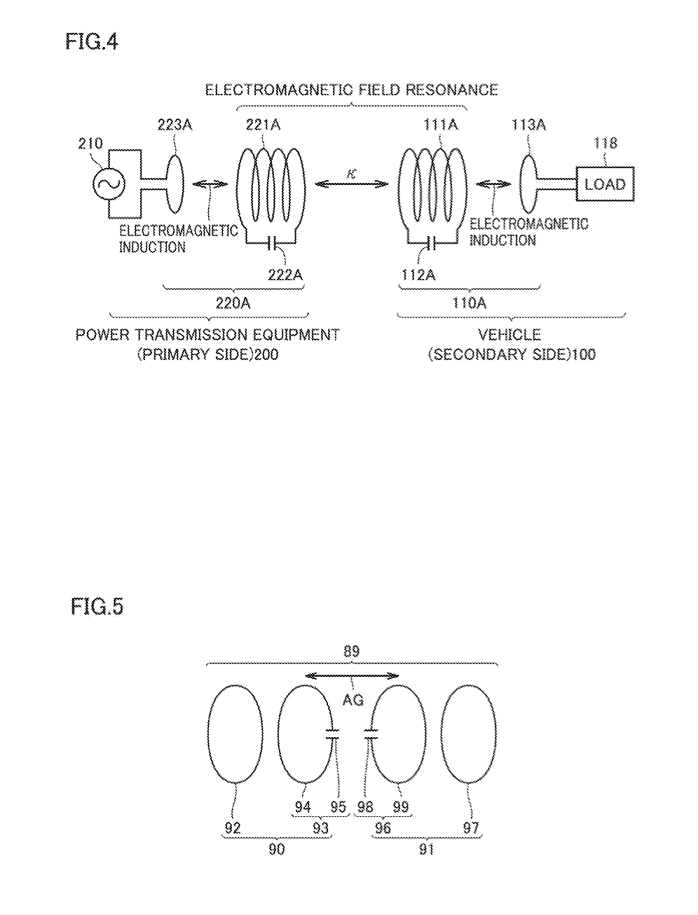

Resonant coil 221 transfers the power transmitted from impedance matching unit 260 to a resonant coil 111 included in power reception unit 110 of vehicle 100 in a contactless manner. Resonant coil 221 and capacitor 222 form an LC resonance circuit. Power transfer between power reception unit 110 and power transmission unit 220 will be described later with reference to FIG. 4.

Communication unit 230 is a communication interface for conducting radio communication between power transmission device 200 and vehicle 100, and provides and receives information INFO to and from a communication unit 160 of vehicle 100. Communication unit 230 receives vehicle information transmitted from communication unit 160 of vehicle 100, signals indicating the start and stop of power transmission, and the like, and outputs the received pieces of information to power transmission ECU 240. Communication unit 230 also transmits information such as power transmission voltage Vtr and power transmission current Itr from power transmission ECU 240 to vehicle 100.

Although not shown in FIG. 1, power transmission ECU 240 includes a CPU (Central Processing Unit), a storage device, an input/output buffer, and the like. Power transmission ECU 240 inputs the signals from various sensors and outputs the control signal to each device while controlling each device in power supply device 210. It is to be noted that the above-described control is not limited to the process by software, but can be carried out by dedicated hardware (an electronic circuit).

Vehicle 100 includes a raising and lowering mechanism 105, power reception unit 110, a matching device 170, a rectifier 180, a charging relay CHR 185, a power storage device 190, a system main relay SMR 115, a power control unit (PCU) 120, a motor generator 130, a motive power transmission gear 140, drive wheels 150, a vehicle ECU (Electronic Control Unit) 300 serving as a control device, communication unit 160, a voltage sensor 195, a current sensor 196, and a position detection sensor 165.

Although an electric car is described as an example of vehicle 100 in this embodiment, the configuration of vehicle 100 is not limited thereto as long as it is capable of running with power stored in a power storage device. Other examples of vehicle 100 include a hybrid vehicle including an engine and a fuel cell vehicle including a fuel cell.

Power reception unit 110 is provided near a floor panel of vehicle 100, and includes resonant coil 111 and a capacitor 112.

Resonant coil 111 receives power from resonant coil 221 included in power transmission device 200 in a contactless manner. Resonant coil 111 and capacitor 112 form an LC resonance circuit.

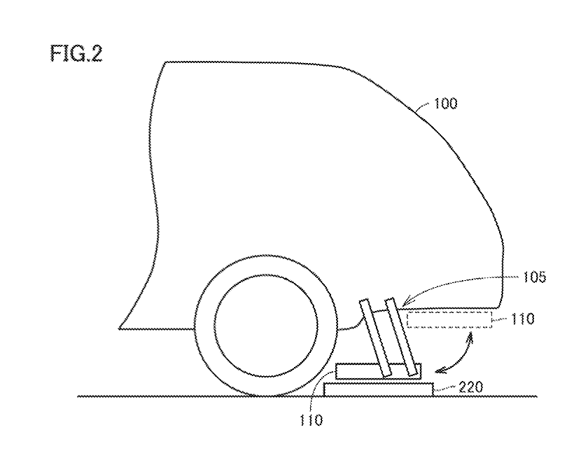

Power reception unit 110 is mounted on raising and lowering mechanism 105. As shown in FIG. 2, raising and lowering mechanism 105 is a moving device for moving power reception unit 110 from a standby position (broken line) to a power reception position facing power transmission unit 220 (solid line) by means of a link mechanism, for example. Raising and lowering mechanism 105 is driven by a not-shown motor, for example, after vehicle 100 has been parked in a predetermined position in a parking space, to move power reception unit 110 from the standby position to the power reception position.

It is to be noted that the power reception position may be set to a predetermined height from the ground, or may be a position where power reception unit 110 comes in contact with power transmission unit 220.

Raising and lowering mechanism 105 includes a ratchet mechanism and is configured to limit the movement of power reception unit 110 below the power reception position but to allow the movement of power reception unit 110 above the power reception position. Consequently, if the vehicle height is lowered, variation in spacing between the floor panel and power reception unit 110 can be absorbed.

The power extracted by resonant coil 111 is output to rectifier 180 through matching device 170. Matching device 170 typically includes a reactor and a capacitor, and matches an input impedance of a load supplied with the power received by resonant coil 111.

Rectifier 180 rectifies the AC power received from resonant coil 111 through matching device 170, and outputs the rectified DC power to power storage device 190. Rectifier 180 may include, for example, a diode bridge and a smoothing capacitor (neither shown). A so-called switching regulator that performs rectification by switching control can also be used as rectifier 180. If rectifier 180 is included in power reception unit 110, the rectifier is more preferably a stationary rectifier such as a diode bridge so as to prevent malfunction and the like of a switching element associated with a generated electromagnetic field.

CHR 185 is electrically connected between rectifier 180 and power storage device 190. CHR 185 is controlled by a control signal SE2 from vehicle ECU 300, and switches between supply and interruption of power from rectifier 180 to power storage device 190.

Power storage device 190 is an electric power storage component configured in a chargeable/dischargeable manner. For example, power storage device 190 includes a secondary battery such as a lithium-ion battery, a nickel-metal hydride battery or a lead-acid battery, or a power storage element such as an electric double layer capacitor.

Power storage device 190 is connected to rectifier 180. Power storage device 190 stores the power received by power reception unit 110 and rectified by rectifier 180. Power storage device 190 is also connected to PCU 120 through SMR 115. Power storage device 190 supplies PCU 120 with power for the generation of driving power of the vehicle. Power storage device 190 also stores power generated by motor generator 130. The output voltage of power storage device 190 is, for example, approximately 200 V.

Although not shown, power storage device 190 is provided with a voltage sensor and a current sensor for detecting a voltage VB of power storage device 190 and a current IB input to and output from power storage device 190, respectively. The detected values from these sensors are output to vehicle ECU 300. Vehicle ECU 300 calculates an SOC (State of Charge) of power storage device 190 based on voltage VB and current IB.

SMR 115 is electrically connected between power storage device 190 and PCU 120. SMR 115 is controlled by a control signal SE1 from vehicle ECU 300, and switches between supply and interruption of power between power storage device 190 and PCU 120.

Although not shown, PCU 120 includes a converter and an inverter. The converter is controlled by a control signal PWC from vehicle ECU 300, and converts a voltage from power storage device 190. The inverter is controlled by a control signal PWI from vehicle ECU 300, and drives motor generator 130 with the power converted by the converter.

Motor generator 130 is an AC rotating electric machine, for example, a permanent magnet type synchronous motor including a rotor having a permanent magnet buried therein.

Output torque of motor generator 130 is transmitted to drive wheels 150 through motive power transmission gear 140. Vehicle 100 runs with this torque. Motor generator 130 can generate power by a rotational force of drive wheels 150 during regenerative braking of vehicle 100. The generated power is converted by PCU 120 into charging power of power storage device 190.

In a hybrid vehicle including an engine (not shown) in addition to motor generator 130, required driving power of the vehicle is generated by cooperatively operating the engine and motor generator 130. In this case, power storage device 190 can be charged with power generated by the rotation of the engine.

Communication unit 160 is a communication interface for conducting radio communication between vehicle 100 and power transmission device 200, and provides and receives information INFO to and from communication unit 230 of power transmission device 200. Information INFO output from communication unit 160 to power transmission device 200 includes vehicle information from vehicle ECU 300, signals indicating the start and stop of power transmission, an indication to switch impedance matching unit 260 of power transmission device 200, and the like.

Although not shown in FIG. 1, vehicle ECU 300 includes a CPU, a storage device, and an input/output buffer. Vehicle ECU 300 inputs the signals from various sensors and outputs the control signal to each device while controlling each device in vehicle 100. It is to be noted that the above-described control is not limited to the process by software, but can be carried out by dedicated hardware (an electronic circuit).

Position detection sensor 165 is provided, for example, on a lower surface of the floor panel of vehicle 100. Position detection sensor 165 is a sensor for detecting power transmission unit 220 so as to confirm a parking position in a parking space provided with power transmission unit 220. Position detection sensor 165 is a magnetic detection sensor, for example, and detects a magnetic force of an electromagnetic field generated by power transmitted from power transmission unit 220 for the position detection during parking operation (hereinafter also referred to as “test power transmission”), then outputs a detection signal SIG to ECU 300. ECU 300 determines whether or not the parking position is appropriate based on detection signal SIG from position detection sensor 165, and prompts the user to stop the vehicle. Alternatively, if vehicle 100 has an automatic parking function, ECU 300 causes an automatic stop of the vehicle based on detection signal SIG.

It is to be noted that position detection sensor 165 is not limited to a magnetic detection sensor as described above, but may be an RFID reader for detecting RFID attached to power transmission unit 220, or may be a distance sensor for detecting a height difference of power transmission unit 220.

In the configuration provided with raising and lowering mechanism 105 as in this embodiment, power reception unit 110 is moved from the standby position to the power reception position. Thus, when power reception unit 110 is stored in the standby position such as during the parking operation, the position detection using power reception unit 110 is difficult. Therefore, position detection sensor 165 is required so as to detect the position of power transmission unit 220 during the parking operation.

Voltage sensor 195 is connected in parallel with resonant coil 111, and detects a power reception voltage Vre received by power reception unit 110. Current sensor 196 is provided on a power line that connects resonant coil 111 and matching device 170 together, and detects a power reception current Ire. The detected values of power reception voltage Vre and power reception current Ire are transmitted to vehicle ECU 300 for use in calculation of power transfer efficiency and the like.

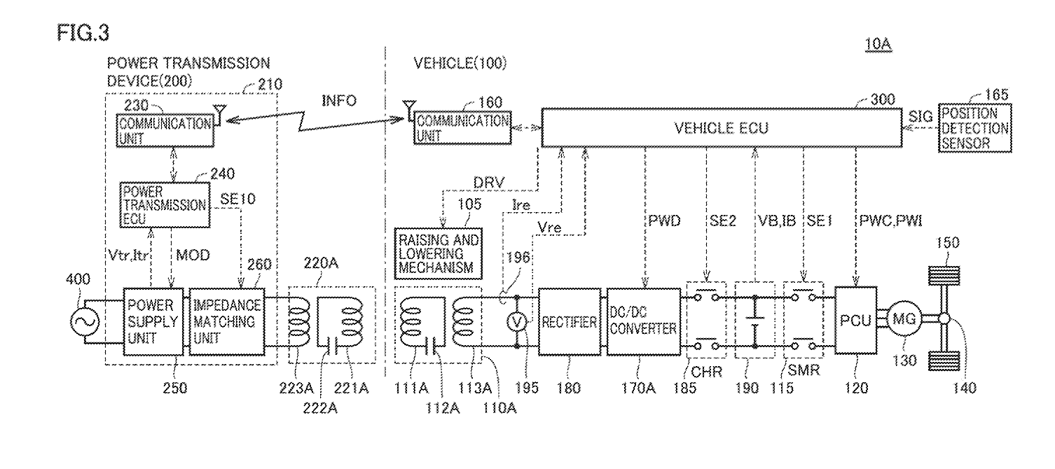

It is to be noted that power reception unit 110 and power transmission unit 220 may be provided with electromagnetic induction coils 113A and 223A, respectively, as with a power reception unit 110A and a power transmission unit 220A in a contactless power feeding system 10A shown in FIG. 3. In this case, electromagnetic induction coil 223A is connected to impedance matching unit 260 in power transmission unit 220A, and transmits power from power supply unit 250 to a resonant coil 221A by electromagnetic induction. Electromagnetic induction coil 113A is connected to rectifier 180 in power reception unit 110A, and extracts the power received by resonant coil 113A by electromagnetic induction and transmits the power to rectifier 180.

In addition, as impedance matching means in the vehicle, as shown in FIG. 3, matching device 170 in FIG. 1 may be replaced by a DC/DC converter 170A that converts a voltage of the DC current rectified by rectifier 180.

(Principle of Power Transfer)

Referring to FIGS. 4 to 8, the principle of power transfer in the contactless power feeding system is described. Although FIGS. 4 to 8 illustrate the configuration including the electromagnetic induction coils shown in FIG. 3 as an example, the basic principle also applies to a configuration not including the electromagnetic induction coils such as shown in FIG. 1. FIG. 4 is an equivalent circuit diagram during power transfer from power transmission device 200 to vehicle 100. Referring to FIG. 4, power transmission unit 220A of power transmission device 200 includes resonant coil 221A, a capacitor 222A, and electromagnetic induction coil 223A.

Electromagnetic induction coil 223A is provided substantially coaxially with resonant coil 221A, for example, at a predetermined distance from resonant coil 221A. Electromagnetic induction coil 223A is magnetically coupled to resonant coil 221A by electromagnetic induction, and supplies high-frequency power supplied from power supply device 210 to resonant coil 221A by electromagnetic induction.

Resonant coil 221A and capacitor 222A form an LC resonance circuit. An LC resonance circuit is also formed in power reception unit 110A of vehicle 100, as will be described later. The difference between a natural frequency of the LC resonance circuit formed of resonant coil 221A and capacitor 222A and a natural frequency of the LC resonance circuit of power reception unit 110A is ±10% or less of the former natural frequency or the latter natural frequency. Resonant coil 221A receives the power from electromagnetic induction coil 223A by electromagnetic induction, and transmits the power to power reception unit 110A of vehicle 100 in a contactless manner.

Electromagnetic induction coil 223A is provided to facilitate the power feeding from power supply device 210 to resonant coil 221A, and power supply device 210 may be connected directly to resonant coil 221A without providing electromagnetic induction coil 223A. Capacitor 222A is provided to adjust the natural frequency of the resonance circuit, and capacitor 222A may not be provided if a desired natural frequency is obtained by utilizing stray capacitance of resonant coil 221A.

Power reception unit 110A of vehicle 100 includes a resonant coil 111A, a capacitor 112A, and electromagnetic induction coil 113A. Resonant coil 111A and capacitor 112A form an LC resonance circuit. As described above, the difference between the natural frequency of the LC resonance circuit formed of resonant coil 111A and capacitor 112A and the natural frequency of the LC resonance circuit formed of resonant coil 221A and capacitor 222A in power transmission unit 220A of power transmission device 200 is ±10% of the former natural frequency or the latter natural frequency. Resonant coil 111A receives power from power transmission unit 220A of power transmission device 200 in a contactless manner.

Electromagnetic induction coil 113A is provided substantially coaxially with resonant coil 111A, for example, at a predetermined distance from resonant coil 111A. Electromagnetic induction coil 113A is magnetically coupled to resonant coil 111A by electromagnetic induction, and extracts the power received by resonant coil 111A by electromagnetic induction and outputs the power to an electrical load device 118. It is to be noted that electrical load device 118 is electrical equipment that utilizes the power received by power reception unit 110A, and specifically, collectively represents electrical equipment at a stage subsequent to rectifier 180 (FIG. 1).

Electromagnetic induction coil 113A is provided to facilitate the extraction of power from resonant coil 111A, and rectifier 180 may be connected directly to resonant coil 111A without providing electromagnetic induction coil 113A. Capacitor 112A is provided to adjust the natural frequency of the resonance circuit, and capacitor 112A may not be provided if a desired natural frequency is obtained by utilizing stray capacitance of resonant coil 111A.

In power transmission device 200, high-frequency AC power is supplied from power supply device 210 to electromagnetic induction coil 223A, and the power is supplied to resonant coil 221A through electromagnetic induction coil 223A. This causes the energy (electric power) to be transferred from resonant coil 221A to resonant coil 111A through a magnetic field formed between resonant coil 221A and resonant coil 111A of vehicle 100. The energy (electric power) transferred to resonant coil 111A is extracted by electromagnetic induction coil 113A and transferred to electrical load device 118 of vehicle 100.

As described above, in this power transfer system, the difference between the natural frequency of power transmission unit 220A of power transmission device 200 and the natural frequency of power reception unit 110A of vehicle 100 is ±10% or less of the natural frequency of power transmission unit 220A or the natural frequency of power reception unit 110A. By setting the natural frequencies of power transmission unit 220A and power reception unit 110A within such a range, the power transfer efficiency can be improved. When the difference in natural frequency becomes greater than ±10%, the power transfer efficiency becomes lower than 10%, which may disadvantageously result in an extended time of power transfer and the like.

The “natural frequency of power transmission unit 220A (power reception unit 110A)” refers to an oscillation frequency at which the electric circuit (resonance circuit) forming power transmission unit 220A (power reception unit 110A) freely oscillates. The natural frequency when the damping force or the electric resistance is set at substantially zero in the electric circuit (resonance circuit) forming power transmission unit 220A (power reception unit 110A) is also referred to as a “resonance frequency of power transmission unit 220A (power reception unit 110A).”

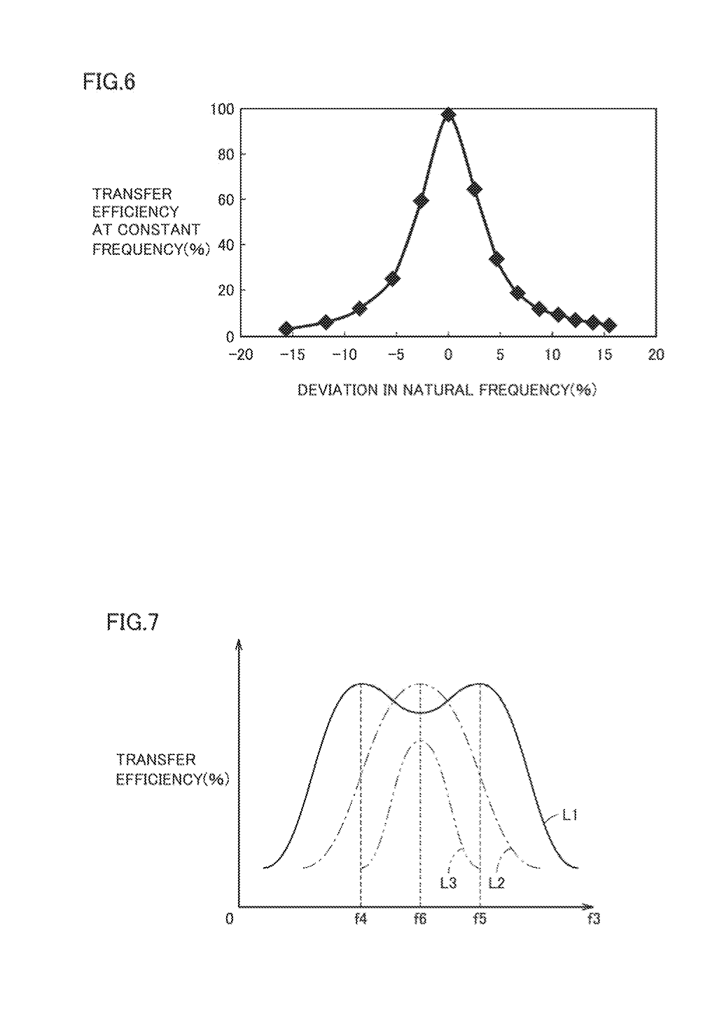

Referring to FIGS. 5 and 6, the following describes a result of simulation in which relation is analyzed between the difference in natural frequency and power transfer efficiency. FIG. 5 is a diagram showing a simulation model of a power transfer system. FIG. 6 is a diagram showing relation between deviation in natural frequency of a power transmission unit and a power reception unit, and the power transfer efficiency.

Referring to FIG. 5, a power transfer system 89 includes a power transmission unit 90 and a power reception unit 91. Power transmission unit 90 includes a first coil 92 and a second coil 93. Second coil 93 includes a resonant coil 94 and a capacitor 95 provided on resonant coil 94. Power reception unit 91 includes a third coil 96 and a fourth coil 97. Third coil 96 includes a resonant coil 99 and a capacitor 98 connected to resonant coil 99.

Assume that the inductance of resonant coil 94 is inductance Lt and the capacitance of capacitor 95 is capacitance C1. Assume that the inductance of resonant coil 99 is inductance Lr and the capacitance of capacitor 98 is capacitance C2. By setting each of the parameters in this way, a natural frequency f1 of second coil 93 is indicated by the following formula (1) and a natural frequency f2 of third coil 96 is indicated by the following formula (2):

f1=1/{2π(Lt×C1)^{1/2}} (1)

f2=1/{2π(Lr×C2)^{1/2}} (2)

Here, FIG. 6 shows relation between the power transfer efficiency and the deviation in natural frequency between second coil 93 and third coil 96 when only inductance Lt is changed with inductance Lr and capacitances C1, C2 being fixed. In this simulation, relative positional relation between resonant coil 94 and resonant coil 99 is fixed, and the frequency of current supplied to second coil 93 is constant.

In the graph shown in FIG. 6, the horizontal axis represents the deviation (%) in natural frequency whereas the vertical axis represents the power transfer efficiency (%) of current at the constant frequency. The deviation (%) in natural frequency is indicated by the following formula (3):

(Deviation in natural frequency)={(f1−f2)/f2}×100(%) (3)

As is apparent from FIG. 6, when the deviation (%) in natural frequency is 0%, the power transfer efficiency is close to 100%. When the deviation (%) in natural frequency is ±5%, the power transfer efficiency is close to 40%. When the deviation (%) in natural frequency is ±10%, the power transfer efficiency is close to 10%. When the deviation (%) in natural frequency is ±15%, the power transfer efficiency is close to 5%. Thus, it is understood that the power transfer efficiency can be improved to a practical level by setting the natural frequency of each of second coil 93 and third coil 96 such that the absolute value of the deviation (%) in natural frequency (difference in natural frequency) falls within a range of 10% or less of the natural frequency of third coil 96. Further, it is more preferable to set the natural frequency of each of second coil 93 and third coil 96 such that the absolute value of the deviation (%) in natural frequency is 5% or less of the natural frequency of third coil 96, so that the power transfer efficiency can be further improved. It is to be noted that electromagnetic field analysis software (JMAG® provided by JSOL Corporation) is employed as simulation software.

Referring back to FIG. 4, power transmission unit 220A of power transmission device 200 and power reception unit 110A of vehicle 100 transmit and receive power in a contactless manner through at least one of a magnetic field formed between power transmission unit 220A and power reception unit 110A and oscillating at a specific frequency, and an electric field formed between power transmission unit 220A and power reception unit 110A and oscillating at a specific frequency. A coupling coefficient κ between power transmission unit 220A and power reception unit 110A is preferably 0.1 or less. By resonating power transmission unit 220A and power reception unit 110A with each other through the electromagnetic field, power is transferred from power transmission unit 220A to power reception unit 110A.

Here, the following describes the magnetic field formed around power transmission unit 220A and having the specific frequency. The “magnetic field having the specific frequency” is typically relevant to the power transfer efficiency and the frequency of current supplied to power transmission unit 220A. First described is relation between the power transfer efficiency and the frequency of the current supplied to power transmission unit 220A. The power transfer efficiency when transferring power from power transmission unit 220A to power reception unit 110A varies depending on various factors such as a distance between power transmission unit 220A and power reception unit 110A. For example, the natural frequencies (resonance frequencies) of power transmission unit 220A and power reception unit 110A are assumed as f0, the frequency of the current supplied to power transmission unit 220A is assumed as f3, and an air gap between power transmission unit 220A and power reception unit 110A is assumed as an air gap AG.

FIG. 7 is a graph indicating relation between the power transfer efficiency when air gap AG is changed with natural frequency f0 being fixed, and frequency f3 of the current supplied to power transmission unit 220A. Referring to FIG. 7, the horizontal axis represents frequency f3 of the current supplied to power transmission unit 220A whereas the vertical axis represents the power transfer efficiency (%). An efficiency curve L1 schematically represents relation between the power transfer efficiency when air gap AG is small and frequency f3 of the current supplied to power transmission unit 220A. As indicated by efficiency curve L1, when air gap AG is small, peaks of the power transfer efficiency appear at frequencies f4, f5 (f4<f5). When air gap AG is made larger, the two peaks at which the power transfer efficiency becomes high are changed to come closer to each other. Then, as indicated by an efficiency curve L2, when air gap AG is made larger than a predetermined distance, one peak of the power transfer efficiency appears. The peak of the power transfer efficiency appears when the current supplied to power transmission unit 220A has a frequency f6. When air gap AG is made further larger from the state of efficiency curve L2, the peak of the power transfer efficiency becomes smaller as indicated by an efficiency curve L3.

For example, as a technique of improving the power transfer efficiency, the following techniques can be considered. A first technique is to change a characteristic of the power transfer efficiency between power transmission unit 220A and power reception unit 110A by changing the capacitances of capacitor 222A and capacitor 112A in accordance with air gap AG with the frequency of the current supplied to power transmission unit 220A being constant. Specifically, with the frequency of the current supplied to power transmission unit 220A being constant, the capacitances of capacitor 222A and capacitor 112A are adjusted to attain a peak of the power transfer efficiency. In this technique, irrespective of the size of air gap AG, the frequency of the current flowing through power transmission unit 220A and power reception unit 110A is constant.

A second technique is to adjust, based on the size of air gap AG, the frequency of the current supplied to power transmission unit 220A. For example, when the power transfer characteristic corresponds to efficiency curve L1, power transmission unit 220A is supplied with current having frequency f4 or f5. When the frequency characteristic corresponds to efficiency curve L2 or L3, power transmission unit 220A is supplied with current having frequency f6. In this case, the frequency of the current flowing through power transmission unit 220A and power reception unit 110A is varied in accordance with the size of air gap AG.

In the first technique, the frequency of the current flowing through power transmission unit 220A becomes a fixed, constant frequency. In the second technique, the frequency thereof flowing through power transmission unit 220A becomes a frequency appropriately varied according to air gap AG. With the first technique, the second technique, or the like, power transmission unit 220A is supplied with a current having a specific frequency set to attain high power transfer efficiency. Because the current having the specific frequency flows through power transmission unit 220A, a magnetic field (electromagnetic field) oscillating at the specific frequency is formed around power transmission unit 220A. Power reception unit 110A receives power from power transmission unit 220A via the magnetic field formed between power reception unit 110A and power transmission unit 220A and oscillating at the specific frequency. Therefore, “the magnetic field oscillating at the specific frequency” is not necessarily a magnetic field having a fixed frequency. It is to be noted that in the above-described example, the frequency of the current supplied to power transmission unit 220A is set based on air gap AG, but the power transfer efficiency also varies according to other factors such as deviation in a horizontal direction between power transmission unit 220A and power reception unit 110A, so that the frequency of the current supplied to power transmission unit 220A may be adjusted based on the other factors.

It is to be noted that the example employing a helical coil as the resonant coil has been described above, but when an antenna such as a meander line antenna is employed as the resonant coil, an electric field having the specific frequency is formed around power transmission unit 220A as a result of flow of the current having the specific frequency through power transmission unit 220A. Through this electric field, power transfer is carried out between power transmission unit 220A and power reception unit 110A.

In this power transfer system, efficiency in power transmission and power reception is improved by employing a near field (evanescent field) in which an “electrostatic magnetic field” of the electromagnetic field is dominant.

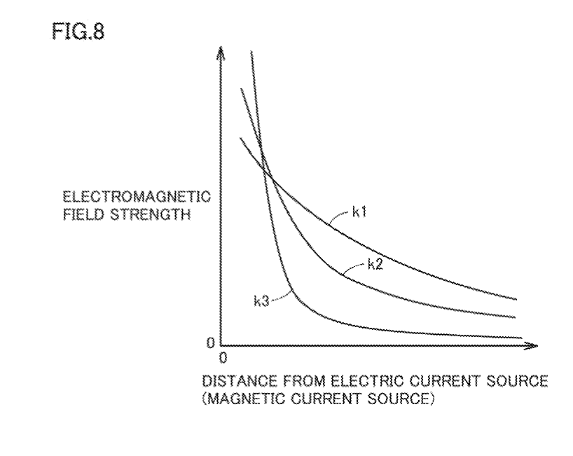

FIG. 8 shows relation between a distance from an electric current source (magnetic current source) and the strength of an electromagnetic field. Referring to FIG. 8, the electromagnetic field is constituted of three components. A curve k1 represents a component in inverse proportion to the distance from the wave source, and is referred to as a “radiation electromagnetic field.” A curve k2 represents a component in inverse proportion to the square of the distance from the wave source, and is referred to as an “induction electromagnetic field.” A curve k3 represents a component in inverse proportion to the cube of the distance from the wave source, and is referred to as an “electrostatic magnetic field.” Assuming that the wavelength of the electromagnetic field is represented by “λ”, λ/2π represents a distance in which the strengths of the “radiation electromagnetic field,” the “induction electromagnetic field,” and the “electrostatic magnetic field” are substantially the same.

The “electrostatic magnetic field” is a region in which the strength of the electromagnetic wave is abruptly decreased as the distance is farther away from the wave source. In the power transfer system according to this embodiment, the near field (evanescent field), in which this “electrostatic magnetic field” is dominant, is utilized for transfer of energy (electric power). In other words, by resonating power transmission unit 220A and power reception unit 110A (for example, a pair of LC resonant coils) having close natural frequencies in the near field in which the “electrostatic magnetic field” is dominant, the energy (electric power) is transferred from power transmission unit 220A to the other side, i.e., power reception unit 110. This “electrostatic magnetic field” does not propagate energy to a distant place. Hence, the resonance method allows for power transmission with less energy loss as compared with the electromagnetic wave in which the “radiation electromagnetic field” propagating energy to a distant place is utilized to transfer energy (electric power).

Thus, in this power transfer system, by resonating power transmission unit 220A and power reception unit 110A with each other through the electromagnetic field, power is transferred in a contactless manner between power transmission unit 220A and power reception unit 110A. The coupling coefficient (κ) between power transmission unit 220A and power reception unit 110A is about 0.3 or less, preferably, 0.1 or less, for example. Naturally, the coupling coefficient (κ) may also fall within a range of about 0.1 to about 0.3. The coupling coefficient (κ) is not limited to such a value, and various values to attain excellent power transfer can be employed.

It is to be noted that coupling coefficient κ varies with the distance between the power transmission unit and the power reception unit. When the air gap between the power transmission unit and the power reception unit is small during power transfer, coupling coefficient κ is between about 0.8 and about 0.6, for example. Naturally, coupling coefficient κ becomes 0.6 or less depending on the distance between the power transmission unit and the power reception unit. When power transfer is carried out between the power transmission unit and the power reception unit located at a distance from each other, coupling coefficient κ becomes 0.3 or less.

It is to be noted that the coupling between power transmission unit 220A and power reception unit 110A as described above during power transfer is called, for example, “magnetic resonant coupling,” “magnetic field resonant coupling,” “electromagnetic field resonant coupling,” “electric field resonant coupling” or the like. The term “electromagnetic field resonant coupling” means coupling including any of the “magnetic resonant coupling,” the “magnetic field resonant coupling,” and the “electric field resonant coupling.”

When power transmission unit 220A and power reception unit 110A are formed of coils as described above, power transmission unit 220A and power reception unit 110A are coupled to each other mainly through a magnetic field to form the “magnetic resonant coupling” or “magnetic field resonant coupling.” It is to be noted that an antenna such as a meander line antenna can be employed, for example, as power transmission unit 220A and power reception unit 110A. In this case, power transmission unit 220A and power reception unit 110A are coupled to each other mainly through an electric field to form the “electric field resonant coupling.”

(Control of Readjustment of Distance Between Coils)

As described above, in a contactless power feeding system, power transfer efficiency may vary depending on the positional relation between a power transmission unit and a power reception unit. In a system of feeding power to a vehicle such as shown in FIG. 1, a vehicle height may vary due to boarding/alighting of an occupant or loading/unloading of baggage to and from a trunk room during power transfer. This vehicle height variation may in turn vary the positional relation between the power transmission unit and the power reception unit, namely, the distance in a vertical direction, thus affecting the power transfer efficiency.

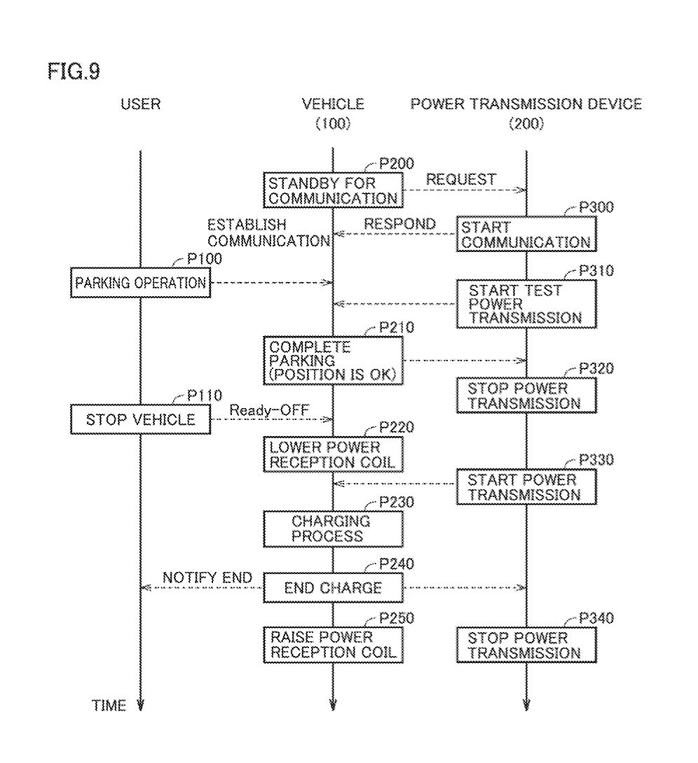

In this embodiment, therefore, when the distance between the power transmission unit and the power reception unit increases due to unloading of an occupant or the like during power transfer, control of readjusting the position of the power reception unit is performed by means of the raising and lowering mechanism such that the power reception unit is located in a predetermined power reception position. Referring now to FIGS. 9 to 12, the control of readjusting the position of the power reception unit in this embodiment is described.

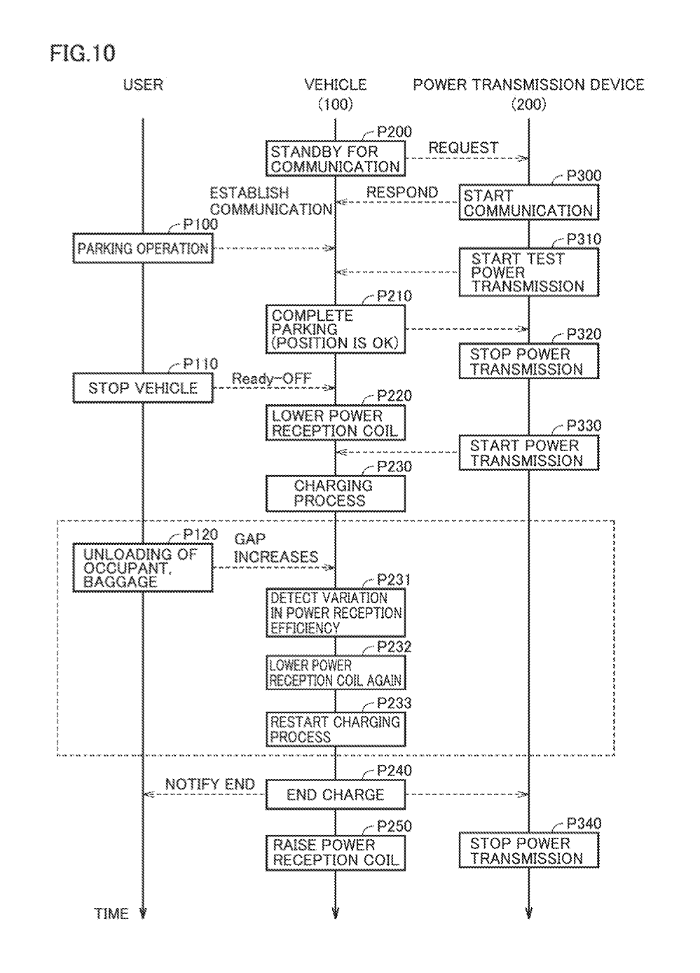

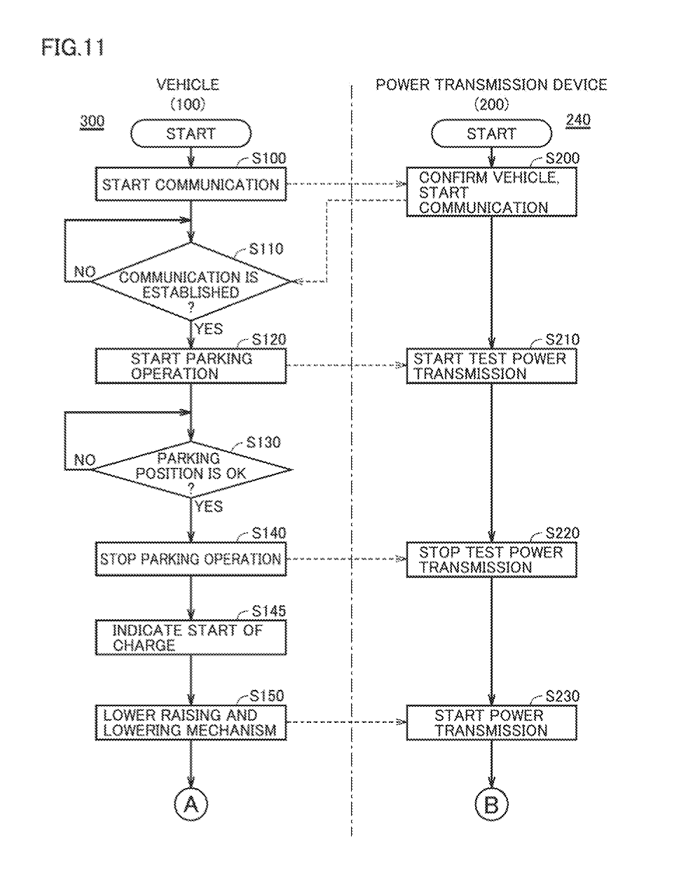

FIGS. 9 and 10 are time charts illustrating a summary of charging operation when there is no variation in vehicle height during power transfer (FIG. 9) and when there is a variation in vehicle height during power transfer (FIG. 10) in this embodiment. In FIGS. 9 and 10, the vertical axis represents time, to schematically illustrate temporal operations of the user, vehicle 100 and power transmission device 200.

Referring to FIGS. 1 and 9, when vehicle 100 approaches the parking space provided with power transmission device 200 so as to charge power storage device 190, vehicle 100 on standby for communication transmits a request signal for establishing communication (P200). In response, power transmission device 200 transmits a response signal for starting communication to vehicle 100 (P300), whereby the communication is established between vehicle 100 and power transmission device 200.

Then, when the user starts the parking operation (P100), power transmission device 200 starts the test power transmission for parking alignment (P310). Vehicle 100 recognizes positional relation between power transmission unit 220 and power reception unit 110 by detecting with position detection sensor 165 a magnetic field generated by the test power transmission. Based on this recognition, vehicle 100 provides the user with guidance on the stop position to assist the user to perform the parking operation. When vehicle 100 has an automatic parking function, vehicle 100 performs the parking operation based on this recognition.

When the parking operation to the predetermined position is completed, vehicle 100 transmits a signal indicating the completion of the parking to power transmission device 200 (P210). In response, power transmission device 200 stops the test power transmission (P320).

Then, the user performs operation of stopping vehicle 100 by operating an ignition switch or an ignition key, causing vehicle 100 to enter a Ready-OFF state (S110). Then, vehicle 100 operates raising and lowering mechanism 105 to lower power reception unit 110 to the position facing power transmission unit 220 (power reception position) (P220).

When the arrangement of power reception unit 110 in the power reception position is completed, power transmission device 200 starts to transmit power for charging power storage device 190 based on an instruction from vehicle 100 (P330). Vehicle 100 receives with power reception unit 110 the power transmitted from power transmission device 200, and performs a process of charging power storage device 190 (P230).

When the charge is completed because power storage device 190 has been fully charged, or when the end of the charging operation is indicated by the user's operation, vehicle 100 stops the charging operation and notifies the user and power transmission device 200 of the end of the charge (P240). Then, vehicle 100 operates raising and lowering mechanism 105 to return power reception unit 110 to the standby position (P250). Meanwhile, power transmission device 200 stops the power transmission operation based on the notification of the end of the charge from vehicle 100 (P340).

Referring now to FIG. 10, the following describes an example where the gap between power transmission unit 220 and power reception unit 110 increases during power transfer due to alighting of an occupant or unloading of baggage. In FIG. 10, operations enclosed by a broken line (P231 to P233) are added to FIG. 9. Description of the operations the same as those in FIG. 9 will not be repeated in FIG. 10.

Power reception unit 110 is arranged in the power reception position by raising and lowering mechanism 105 (P220), and the charging process is performed with the power received from power transmission device 200 (P230). In this state, when the vehicle height varies due to alighting of an occupant or unloading of baggage from the trunk room, the gap between power transmission unit 220 and power reception unit 110 increases (P120).

Vehicle 100 recognizes that the gap between power transmission unit 220 and power reception unit 110 has increased by calculating the power transfer efficiency based on the received power and information about the transmitted power received from power transmission device 200 through communication, and detecting a variation (reduction) in power transfer efficiency (P231). Upon detecting the gap increase, vehicle 100 lowers raising and lowering mechanism 105 again to reduce the gap (P232), then restarts the charging process (P233). Although not shown in FIG. 10, the power transmission from power transmission device 200 may be suspended while raising and lowering mechanism 105 is lowered again.

Then, in response to a transition to a fully charged state, or in response to the user's operation of ending the charge, the charging operation of vehicle 100 and the power transmission operation of power transmission device 200 are stopped (P240, P340).

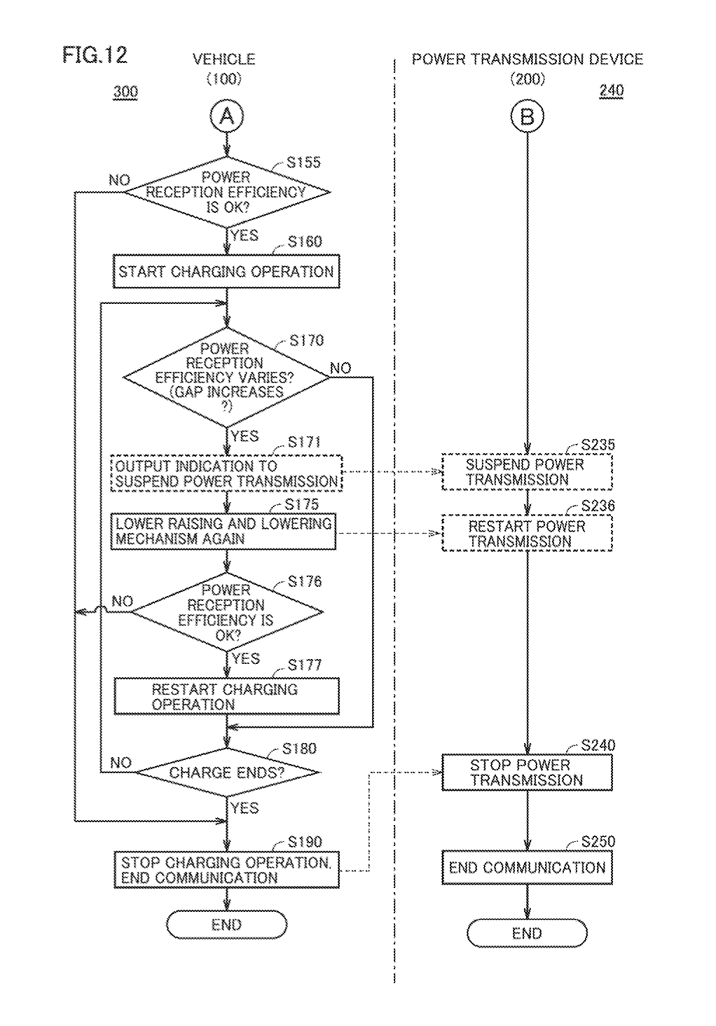

FIGS. 11 and 12 are flowcharts for illustrating control of readjusting the position of the power reception unit which is performed during the power transfer in this embodiment. Each step in the flowcharts shown in FIGS. 11 and 12 is implemented by executing a program prestored in vehicle ECU 300 or power transmission ECU 240 in a predetermined cycle. Alternatively, some of the steps can be implemented by constructing dedicated hardware (an electronic circuit).

Referring to FIGS. 11 and 12, in step (the step being abbreviated as S hereinafter) 100, vehicle 100 transmits a request signal for starting communication with power transmission device 200. Power transmission ECU 240 receives this request signal and confirms vehicle 100, then transmits a response signal for starting communication with vehicle 100 to vehicle 100 (S200).

In S110, vehicle ECU 300 determines whether or not the response signal from power transmission device 200 in response to the above request signal has been received, that is, whether or not the communication with power transmission device 200 has been established. When the communication with power transmission device 200 has not been established (NO in S110), the process returns to S110 where vehicle ECU 300 continues to determine whether or not the response signal from power transmission device 200 has been received.

When the communication with power transmission device 200 has been established (YES in S110), the process proceeds to S120 where the parking operation to the parking space provided with power transmission device 200 is started by the user's operation or the automatic parking function. Following the start of the parking operation, power transmission ECU 240 causes power transmission unit 220 to start the test power transmission (S210).

In S130, vehicle ECU 300 determines whether or not the movement to the predetermined parking position has been completed by detecting with position detection sensor 165 a magnetic force transmitted from power transmission unit 220. When the movement to the predetermined parking position has not been completed (NO in S130), the process returns to S130 where vehicle ECU 300 continues to confirm the position by means of position detection sensor 165 while the parking operation is continued.

When the movement to the predetermined parking position has been completed (YES in S130), in S140, the parking operation is stopped by the automatic parking function or the user's operation. In response, power transmission ECU 240 stops the test power transmission (S220).

Then, when operation of starting the charge is performed by the user (S145), in 5150, vehicle ECU 300 lowers raising and lowering mechanism 105 to move power reception unit 110 to the power reception position facing power transmission unit 220. In response, power transmission ECU 240 starts to transmit power greater than that for the test power transmission (S230).

In S155, vehicle ECU 300 calculates the power transfer efficiency (power reception efficiency) to determine whether or not the power transfer efficiency is equal to or higher than a predetermined value. When the power transfer efficiency is lower than the predetermined value (NO in S155), the process proceeds to S190 where vehicle ECU 300 stops the charging operation and instructs power transmission device 200 to stop the power transmission. Then, vehicle ECU 300 ends the communication with power transmission device 200. In response, power transmission ECU 240 stops the power transmission operation (S240), and ends the communication with vehicle 100 (S250).

When the power transfer efficiency is lower than the predetermined value, the user may be notified and prompted to perform the parking operation again.

When the power transfer efficiency is equal to or higher than the predetermined value (YES in S155), the process proceeds to S160 where vehicle ECU 300 starts the operation of charging power storage device 190.

During the charging operation, vehicle ECU 300 continually monitors the power transfer efficiency and determines whether or not the power transfer efficiency has been reduced due to an increase in gap between power transmission unit 220 and power reception unit 110 (S170). More specifically, it is determined whether or not the power transfer efficiency has become lower than a predetermined threshold value α1.

When the power transfer efficiency has not been reduced (NO in S170), the process proceeds to S180 where vehicle ECU 300 determines whether or not the end of the charge has been indicated because power storage device 190 has been fully charged, or by the user's operation of ending the charge. When the end of the charge has not been indicated (NO in S180), the process returns to S170 where the charging operation is continued.

When the end of the charge has been indicated (YES in S180), the process proceeds to S190 where vehicle ECU 300 stops the charging operation.

When a reduction in power transfer efficiency is detected in S170 (YES in S170), on the other hand, the process proceeds to S171 where vehicle ECU 300 causes power transmission device 200 to suspend the power transmission (S235).

Then, in 5175, vehicle ECU 300 lowers raising and lowering mechanism 105 again so as to reduce the gap between power transmission unit 220 and power reception unit 110. When the operation of raising and lowering mechanism 105 is completed, ECU 300 causes power transmission device 200 to restart the power transmission (S236). It is to be noted that the suspension (S235) and the restart (S236) of the power transmission by power transmission device 200 is optional, and raising and lowering mechanism 105 may be operated while the power transmission is continued.

Then, in S176, vehicle ECU 300 determines whether or not the power transfer efficiency is equal to or higher than a threshold value α2, which is set to be equal to or higher than threshold value α1 in S170 (α1≦α2). If raising and lowering mechanism 105 uses the link mechanism as shown in FIG. 2, for example, lowering of raising and lowering mechanism 105 causes movement of power reception unit 110 in a direction of forward movement of the vehicle as well. Thus, when raising and lowering mechanism 105 is lowered again, power transmission unit 220 and power reception unit 110 may not necessarily face each other properly due to the movement in the forward direction. Accordingly, it is preferable to confirm the power transfer efficiency again after the adjustment of the position of power reception unit 110.

When the power transfer efficiency is lower than threshold value α2 (NO in S176), the process proceeds to S190 where vehicle ECU 300 stops the charging operation. When the power transfer efficiency is equal to or higher than the predetermined value (YES in S176), on the other hand, the process proceeds to S177 where vehicle ECU 300 restarts the charging operation. The process then proceeds to S180 where it is determined whether or not to end the charge as described above.

By performing the control in accordance with the process as described above, in the contactless power feeding system in which the vehicle is provided with the raising and lowering mechanism capable of adjusting the positional relation between the power transmission unit and the power reception unit, when the distance between the power transmission unit and the power reception unit varies during power transfer, the positional relation between the power reception unit and the power transmission unit can be readjusted by means of the raising and lowering mechanism. Consequently, a reduction in power transfer efficiency during power transfer resulting from the variation in distance between the power transmission unit and the power reception unit can be prevented.

The embodiment above describes the configuration where the vehicle is provided with the raising and lowering mechanism to adjust the position (height) of the power reception unit. Alternatively or additionally, the configuration may be such that the power transmission unit is provided with a raising and lowering mechanism that adjusts the position of the power transmission unit. Again in this case, when the distance between the power transmission unit and the power reception unit increases, the distance between the power transmission unit and the power reception unit can fall within a predetermined range by raising or lowering the raising and lowering mechanism on the power transmission unit to bring the power transmission unit and the power reception unit closer together, thereby preventing a reduction in power transfer efficiency.

The embodiment above describes an example in which the position where the power transmission unit and the power reception unit are substantially in contact with each other is set as the power reception position, namely, an example in which the power transfer is carried out with the distance between the power transmission unit and the power reception unit being substantially zero during the power transfer, and the position variation with a reduction in vehicle height is absorbed by the ratchet mechanism or the like. However, when a position at a predetermined distance, which is not zero, from the surface of the power transmission unit is set as the power reception position of the power reception unit, the position of the power reception unit may be readjusted by raising the raising and lowering mechanism in response to a reduction in distance between the power reception unit and the power transmission unit due to boarding of an occupant or loading of baggage.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

10, 10A contactless power feeding system; 89 power transfer system; 90, 220, 220A power transmission unit; 91, 110, 110A power reception unit; 92, 93, 96, 97 coil; 94, 99, 111, 111A, 221, 221A resonant coil; 95, 98, 112, 112A, 222, 222A capacitor; 100 vehicle; 105 raising and lowering mechanism; 113, 223 electromagnetic induction coil; 115 SMR; 118 electrical load device; 120 PCU; 130 motor generator; 140 motive power transmission gear; 150 drive wheel; 160, 230 communication unit; 165 position detection sensor; 170 matching device; 170A DC/DC converter; 180 rectifier; 190 power storage device; 195 voltage sensor; 196 current sensor; 200 power transmission device; 210 power supply device; 240 power transmission ECU; 250 power supply unit; 260 impedance matching unit; 300 vehicle ECU; 400 commercial power supply.

1. A vehicle capable of receiving power from a power transmission device in a contactless manner, comprising:
a power reception unit that receives power from a power transmission unit included in the power transmission device in a contactless manner;
a moving device configured to move the power reception unit between a standby position and a power reception position facing the power transmission unit; and
a control device for controlling the moving device,
after the power reception unit has been moved to the power reception position and during reception of power from the power transmission unit, when a distance between the power transmission unit and the power reception unit becomes greater than the distance at a start of the reception of power, the control device being configured to operate the moving device to bring the power reception unit closer to the power transmission unit.

2. The vehicle according to claim 1, wherein
when the distance becomes greater than a first predetermined value during the reception of power from the power transmission unit, the control device causes the power transmission unit to suspend power transmission and reoperates the moving device so as to adjust the distance.

3. The vehicle according to claim 2, wherein
the control device causes the power transmission unit to restart the power transmission in response to the distance becoming smaller than a second predetermined value by the reoperation of the moving device, the second predetermined value being set to be equal to or lower than the first predetermined value.

4. The vehicle according to claim 1, wherein
the control device determines the distance based on power transfer efficiency from the power transmission unit to the power reception unit.

5. The vehicle according to claim 4, wherein
when the power transfer efficiency becomes lower than a first threshold value, the control device causes the power transmission unit to suspend power transmission and operates the moving device, and causes the power transmission unit to restart the power transmission in response to the power transfer efficiency becoming higher than a second threshold value, the second threshold value being set to be equal to or higher than the first threshold value.

6. The vehicle according to claim 1, wherein
a difference between a natural frequency of the power transmission unit and a natural frequency of the power reception unit is ±10% or less of the natural frequency of the power transmission unit or the natural frequency of the power reception unit.

7. The vehicle according to claim 1, wherein
a coefficient of coupling between the power transmission unit and the power reception unit is 0.1 or less.

8. The vehicle according to claim 1, wherein
the power reception unit receives power from the power transmission unit through at least one of a magnetic field formed between the power reception unit and the power transmission unit and oscillating at a specific frequency, and an electric field formed between the power reception unit and the power transmission unit and oscillating at a specific frequency.

9. A power reception device that receives power from a power transmission device in a contactless manner, comprising:
a power reception unit that receives power from a power transmission unit included in the power transmission device in a contactless manner;
a moving device configured to move the power reception unit between a standby position and a power reception position facing the power transmission unit; and
a control device for controlling the moving device,
after the power reception unit has been moved to the power reception position and during reception of power from the power transmission unit, when a distance between the power transmission unit and the power reception unit becomes greater than the distance at a start of the reception of power, the control device being configured to operate the moving device to bring the power reception unit closer to the power transmission unit.

10. A power transmission device that supplies power to a power reception device in a contactless manner, comprising:
a power transmission unit that supplies power to a power reception unit included in the power reception device in a contactless manner;
a moving device configured to move the power transmission unit between a standby position and a power transmission position facing the power reception unit; and
a control device for controlling the moving device,
after the power transmission unit has been moved to the power transmission position and during transmission of power to the power reception unit, when a distance between the power transmission unit and the power reception unit becomes greater than the distance at a start of the transmission of power, the control device being configured to operate the moving device to bring the power transmission unit closer to the power reception unit.

11. A contactless power feeding system including a power transmission unit and a power reception unit, for supplying power from the power transmission unit to the power reception unit in a contactless manner, the contactless power feeding system comprising:
a moving device configured to move at least one of the power transmission unit and the power reception unit from a standby position to a power reception position; and
a control device for controlling the moving device,
during reception by the power reception unit of power from the power transmission unit in the power reception position, when a distance between the power transmission unit and the power reception unit becomes greater than the distance at a start of the reception of power, the control device being configured to operate the moving device to bring the power reception unit and the power transmission unit closer to each other.
